(19) United States
(12) Patent Application Publication
(10) Pub. No.: US 2010/0074085 A1
(43) Pub. Date: Mar. 25, 2010

(54) RECORDING METHOD AND A RECORDER

(75) Inventors: Donato PASQUARIELLO, KISTA (SE); Ronald Joseph Antonius VAN DEN OETELAAR, EINDHOVEN (NL); Jacobus Maarten den HOLLANDER, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/527,447

(22) PCT Filed: Feb. 19, 2008
(86) PCT No.: PCT/IB2008/050589

§ 371 Date: Aug. 17, 2009

(30) Foreign Application Priority Data
Feb. 19, 2007 (EP) 07102616.5

(51) Int. Cl. G11B 7/00

(52) U.S. Cl. 369/100; G9B/7

(57) ABSTRACT

A method (400) comprising recording content on at least one of a plurality of recording layers on an optical record carrier by means of a focused radiation beam, wherein the selection of the recording layer for recording the content is based on at least one of the following recording criteria: —characteristics of the content; —properties of the plurality of recording layers; —manual selection by an end user; and —automatic selection is disclosed. The method is useful for recording content on multi-layer optical discs such as DVD and Blu-raydiscs.

### FIELD OF THE INVENTION

The subject matter relates to a recording method and more specifically to recording of content on a multi-layer optical disc.

### BACKGROUND OF THE INVENTION

Patent document WO 2004112022 discloses an apparatus for processing information stored in a data carrier in which information can be stored in many layers. The different layers will have different properties. The read-out of the stored information can be affected based on the properties of the layer on which the information is stored.

It would be advantageous to have a recording method that records different content on different recording layers. It would also be advantageous to have a recording device that records different content on different recording layers.

### SUMMARY OF THE INVENTION

A method comprising recording content on at least one of a plurality of recording layers on an optical record carrier by means of a focused radiation beam, wherein the selection of the recording layer for recording the content is based on at least one of the following recording criteria:

characteristics of the content;

properties of the plurality of recording layers;

manual selection by an end user; and

automatic selection is disclosed.

A recorder comprising a control unit arranged to record content on at least one of a plurality of recording layers on an optical record carrier by means of a focused radiation beam, wherein the selection of the recording layer for recording the content is based on at least one of the following recording criteria:

characteristics of the content;

properties of the plurality of recording layers;

manual selection by an end user; and

automatic selection is disclosed.

Furthermore, the method of recording the content could be implemented with a computer program.

### BRIEF DESCRIPTION OF THE DRAWINGS

The above mentioned aspects, features and advantages will be further described, by way of example only, with reference to the accompanying drawings, in which the same reference numerals indicate identical or similar parts, and in which:

FIG. 1 schematically shows the structure of an example four layer optical record carrier;

FIG. 2 schematically illustrates repeated read behavior of an example BD-R disc at read powers of 0.7 mW, 0.9 mW, 1.0 mW and 1.2 mW;

FIG. 3 schematically illustrates repeated read behavior of a layer in a multi-layer optical record carrier comprising a metal layer in the recording stack and an example layer in a multi-layer optical record carrier without a metal layer in the recording stack;

FIG. 4 shows an example of a flowchart illustrating detailed steps of the method of recording the content according to an embodiment of the present subject matter; and

FIG. 5 schematically shows an example block diagram of an exemplary recorder according to an embodiment of the present subject matter.

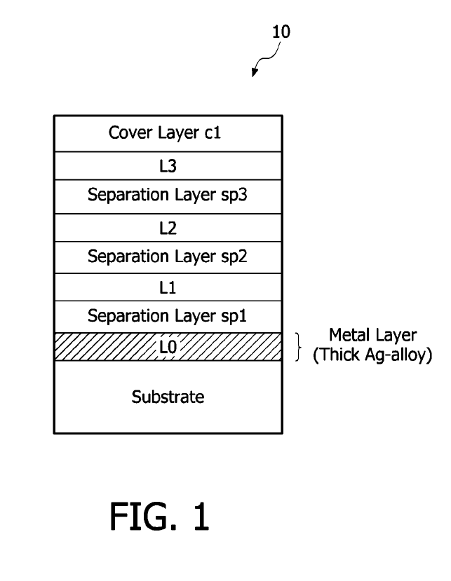

Referring to the example four layer optical record carrier 10 in FIG. 1, a plurality of recording layers L0, L1, L2 and L3 is formed above a first surface of a substrate. A plurality of separation layers sp1, sp2 and sp3 is disposed between the recording layers L0, L1 and L2 respectively. A cover layer cl is disposed above the top recording layer L3. It is to be noted that the optical record carrier 10 has recording layer, stack and material layer. The material layers in the optical record carrier 10 can be made of (for example) ZnS, SiO2, Cu, Si and Ag. The stack of the recording layer L1, L2 and L3 consist of material layers ZnS, SiO2, Cu and Si. The material layers generally have a thickness of approximately about 5-15 nm. There can be no thick metal layer in the top recording layers, L3, L2 and L1 because they need to be semi-transparent. The bottom recording layer L0 comprises a substantially thick metal layer (e.g. thick Ag-mirror approximately 100-150 nm thick). The thick metal layer can only be in the bottom recording layer L0 because the bottom layer doesn't have to be transparent. It is noted here that only for illustration purpose a four layer optical record carrier is shown and it is possible to have any number of layers (e.g. two layers, three layers, four layers, six layers, eight layers).

The transmission through the top recording layer(s) has to be very high in order to record and read-out all the recording layers. The higher the number of recording layers, higher will be the transmission needed by the top recording layer. As an illustrative example the transmission of the individual recording layers that are required to reach an effective reflection of 4% from each layer (4% reflection is the minimum reflection from each layer in the current Blu-ray disc standard (System description Blu-ray disc recordable format, Part 1, Basic format specifications; System description Blu-ray disc rewritable format, Part 1, Basic format specifications)) are calculated. The results are shown in Table 1.

TABLE 1
Calculated transmission through each single individual recording layer

| Recording | Reflection | Transmission | Effective |
|---|---|---|---|
| layer | (individual layer), r | (individual layer), t | Reflection, R |
| L3 | 4% | 82% | 4% |
| L2 | 6% | 74% | 4% |
| L1 | 11% | 63% | 4% |
| L0 | 27% | 0% | 4% |

The data in Table 1 are calculated using the following formulas:

R₀=t₃\t₂\t₁)²×r₀

R₁=(t₁\t₂)²×r₁

R₂=(t₃)²×r₂

R₃=r₃

where

tₙ and rₙ are the transmission and reflection from the individual recording layers respectively; and

Rₙ is the reflectivity from the n^{th} layer (i.e., L3) in the four layer optical record carrier shown in FIG. 1.

It can be observed from Table 1 that the transmission of the top recording layers L3, L2, and L1 need to be very high, i.e. 60-80%. Reaching such high transmission excludes the use of any metal layer in the top stacks. Therefore, unavoidably these upper layers will also have very poor cooling. Metal layers are often used as heat sinks to improve cooling of the recording stack.

In most optical disc standards (System description Blu-ray disc recordable format, Part 1, Basic format specifications; System description Blu-ray disc rewritable format, Part 1, Basic format specifications) the “repeated read” is specified. It is often specified that one should be able to read-out the data 1.000.000 times at a certain minimum read power without degrading the recorded data.

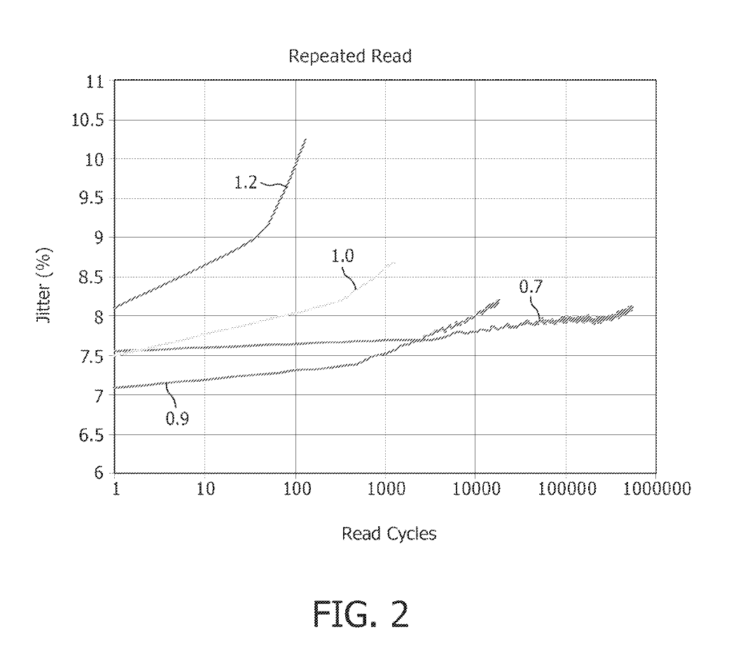

Referring to FIG. 2, the vertical axis represents the Jitter (in %) and the horizontal axis represents the number of repeated read cycles. It can be seen that the higher the read power, the faster the jitter increases (data degrades). During repeated read the radiation source (e.g. laser) slowly heats up the disc, which causes degradation of the recorded data. The better the cooling properties of the recording stack, the more stable the recording stack is during repeated read. Read stability is directly linked to the cooling properties of the stack.

### DETAILED DESCRIPTION OF THE EMBODIMENTS

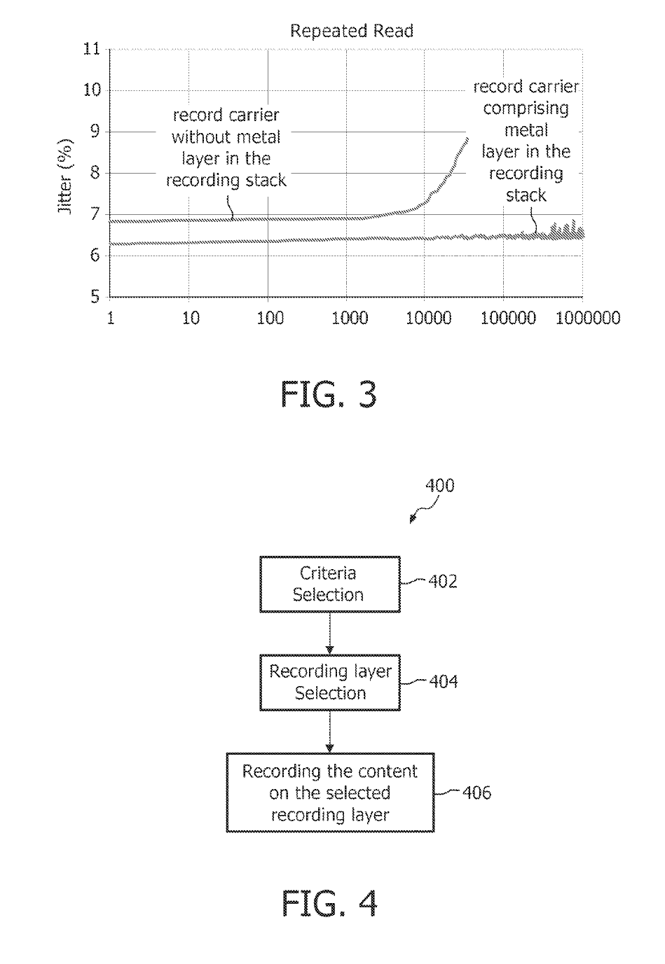

In a multi-layer optical record carrier 10 (Cf. FIG. 1), the different recording layers can have different properties, for example cooling arising from the fact that the top layers need to have very high optical transmission whereas the bottom layer does not. FIG. 3 schematically illustrates repeated read behavior of a layer in a multi-layer optical record carrier comprising a metal layer in the recording stack and an example layer in a multi-layer optical record carrier without a metal layer in the recording stack. The horizontal axis represents the number of repeated reads and the vertical axis represents the Jitter (in %). Optical record carrier without the metal layer in the recording stack reaches about 10,000 read cycles before the jitter starts to increase, whereas the optical record carrier 10 (Cf. FIG. 1) with the metal layer in the recording stack is stable to over 1,000,000 read cycles. The thick metal layer (e.g. Ag-alloy) in the optical record carrier 10 improves cooling of the stack; consequently the repeated read stability of the bottom layer L0 (Cf. FIG. 1) is very good.

A method comprising recording content on at least one of a plurality of recording layers on an optical record carrier by means of a focused radiation beam, wherein the selection of the recording layer for recording the content is based on at least one of the following recording criteria:

characteristics of the content;

properties of the plurality of recording layers;

manual selection by an end user; and

automatic selection is disclosed.

As the types of content that is to be recorded on the optical record carrier increases, it becomes more likely that some types of content are read often and the remaining types of content are read less often. Hence, recording the content on an appropriate recording layer on the optical record carrier based on the characteristics/properties of the content ensures good read-out performance and enhances the experience of the user.

Referring to FIG. 4, in step 402 a criterion is selected from the group consisting of i) characteristics of the content ii) properties of the plurality of recording layers iii) manual selection by an end user and iv) automatic selection. In step 404, based on the evaluation results of the criteria selected, one of the recording layers (i.e., one of L0, L1, L2 and L3) is selected for recording the content. In step 406, the content is recorded on the selected recording layer.

In an embodiment, in recording the content, the selection of the at least one recording layer is based on repeated read performance property of the recording layer. This is advantageous since the content that has to be read-out many times can be recorded on the recording layer that offers good repeated read performance stability.

In a further embodiment, in recording the content, one of the plurality of recording layers is a first recording layer L0 (Cf. FIG. 1) disposed above a first surface of a substrate and the first recording layer L0 comprises a substantially thick metal layer (i.e. acting as a heat sink). The thick metal layer (e.g. Ag-mirror) improves cooling of the first recording layer L0 and therefore the first recording layer has much better repeated read performance. Furthermore, since the first recording layer happens to be the layer with very good read stability, the recorded content can be read-out at higher speeds. It is further noted here that the first recording layer L0 is the bottom recording layer (i.e. recording layer that is farthest from the radiation beam source) as viewed from a recording/reproducing unit.

In a still further embodiment, the content to be recorded comprises files and the characteristics of the content is selected from one of the

number of times the content is read-out and

speed at which the content is read-out.

For CE (consumer electronic) applications, normally all the content (e.g. music and movies are read at the same speed. However, for PC applications it is of course advantageous to read out the content as fast as possible since this improves the access time (e.g. of software).

In a still further embodiment, the number of times the content is read-out is determined based on type of file. It is likely that a file with extension jpeg, doc or ppt will be read out many times. The type of file extension can be selected from the group consisting of i) joint photographers group (jpeg) and ii) moving picture experts group (mpeg). Jpeg and mpeg files generally include the primary data associated with the content that are frequently read-out. Hence it is advantageous to record the jpg and the mpeg, files on the first recording layer L0 (Cf. FIG. 1) that has good repeated read stability. On the other hand, the secondary files associated with the content are generally accessed less frequently and hence is advantageous to record them on the other recording layers namely L1, L2 and L3 (Cf. FIG. 1).

The content comprising an executable game program can be recorded on the first recording layer L0 (Cf. FIG. 1) and the data associated with the game program can be recorded on at least one of the plurality of recording layers (L1, L2, L3) above the first recording layer L0. It is advantageous to record the executable game application program on the first recording layer L0, since it is read most often from the optical record carrier 10 (Cf. FIG. 1). The additional data associated with the game program such as maps, creatures that are less frequently read-out (only when required by the gaming program) from the optical record carrier 10 is recorded on the recording layers L1, L2 and L3.

In a still further embodiment, in the manual selection by the end user, the end user selects one of the plurality of recording layers to record the content. As an illustrative example, let us consider a navigation system, which retrieves its map-data from the optical record carrier 10. The optical record carrier 10 has very large capacity to contain detailed map of a large region including additional information (picture, movies etc). Even though the optical record carrier 10 is the same for user A and user B, each user will access different areas on the optical record carrier 10 based on their geographical location and their interests. If the user A has to record some additional data associated with the geographical location of his interest which the user wants to read frequently, then the user can select the first recording layer L0 (since the first recording layer L0 has good repeated read stability). This improves the read-out performance and enhances user satisfaction.

In a still further embodiment, an application program of a recording device selects one of the plurality of recording layers to record the content. This is advantageous since the user need not know where to record the content and the application program automatically decides the layer on which the content is to be recorded based on the characteristics of the content and/or the properties of the plurality of recording layers.

In a still further embodiment, the optical record carrier is one of DVD and Blu-ray disc. The types of content available are increasing and the storage capacity of DVD's and Blu-ray discs is also increasing and four layer/six layer Blu-ray discs are expected to come to the market. Hence, it is advantageous to have a recording method that can record content based on nature of the content.

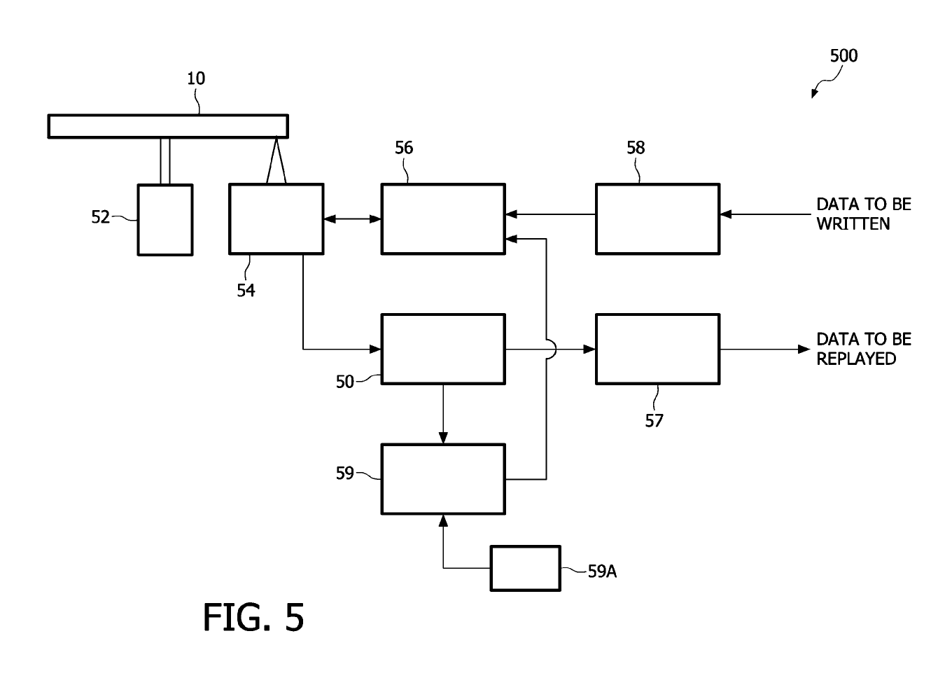

Referring to FIG. 5, the optical record carrier 10 (Cf. FIG. 1) is constant angular velocity (CAV) controlled or constant linear velocity (CLV) controlled by a spindle motor 52. An optical pick-up unit 54 records data on the optical record carrier 10 by using laser light (at a recording power value) emitted from a laser diode. When the data is to be recorded, it is supplied to an encoder unit 58 and the data encoded by the encoder unit 58 is supplied to a laser diode-driving unit 56. The laser diode-driving unit 56 generates a drive signal based on the encoded data and supplies the drive signal to the laser diode of the optical pick-up unit 54. In addition, a control signal from a control unit 54 is supplied to the laser diode-driving unit 56 so that the recording strategy and recording power are determined by the control signal.

However, when the content is read from the optical record carrier 10, the laser diode of the optical pick-up unit 54 emits laser light of a read power (read power<record power), and the reflected light is received. The received reflected light is converted into an electrical signal and a read RF signal is obtained. The read RF signal is supplied to an RF signal-processing unit 50.

The RF signal-processing unit 50 comprises an equalizer, a binarizing unit, a phase-locked loop (PLL) unit, and binarizes the read RF signal, generates a synchronous clock, and supplies these signals to a decoder unit 57. The decoder unit 57 decodes data based on these supplied signals and outputs the decoded data as read data.

The device 500 also includes a circuit (for data read-out) for controlling the focus servo or tracking servo by producing a tracking error signal or a focus error signal respectively, and a wobble signal formed on the optical record carrier 10 (e.g. for use in address demodulation or for controlling the number of rotations). The servo control structures are identical to those in conventional drive systems and therefore are not described in detail.

The construction shown in FIG. 5 only illustrates portions related to the general operation of the recording device 500. The description and detailed explanation of servo circuits for controlling the optical pick-up unit, the spindle motor, the slide motor, and the control circuits are omitted, because they are constructed in a similar manner as in conventional systems.

The control unit 59 is arranged to record content on at least one of a plurality of recording layers on the optical record carrier by means of a focused radiation beam, wherein the selection of the recording layer for recording the content is based on at least one of the following recording criteria:

characteristics of the content;

properties of the plurality of recording layers:

manual selection by an end user; and

automatic selection.

The control unit 59 further comprises a determining unit 59A arranged to determine the number of times the content is read-out based on the type of file.

The recorder can be one of DVD recorder and Blu-ray disc recorder.

Although the present subject matter has been explained by means of embodiments using multi-layer Blu-ray discs, the subject matter is applicable to all types of record carriers (e.g. HD-DVD, DVD, and CD). The present subject matter is not limited to a two-layer one side disc, i.e., a dual layer disc, and to a two-layer double-side disc, i.e., a dual layer double-side disc. A person skilled in the art can implement the described embodiments of the method of recording content in software or in both hardware and software. Other variations to the disclosed embodiments can be understood and effected by those skilled in the art of practicing the claimed subject matter, from a study of the drawings, the disclosure and the appended claims. The user of the verb “comprise” does not exclude the presence of elements other than those stated in a claim or in the description. The use of the indefinite article “a” or “an” preceding an element does not exclude the presence of a plurality of such elements. The Figures and description are to be regarded as illustrative only and do not limit the subject matter.

1. A method (400) comprising:
recording content on at least one of a plurality of recording layers on an optical record carrier by means of a focused radiation beam, wherein the selection of the recording layer for recording the content is based on at least one of the following recording criteria:
characteristics of the content;
properties of the plurality of recording layers;
manual selection by an end user; and
automatic selection.

2. The method as claimed in claim 1, wherein, in recording the content, the selection of the at least one recording layer is based on repeated read performance property of the plurality of recording layers.

3. The method as claimed in claim 2, wherein, in recording the content, one of the plurality of recording layers is a first recording layer disposed above a first surface of a substrate and wherein the first recording layer comprises a substantially thick metal layer.

4. The method as claimed in claim 3, wherein the content comprises files and the characteristics of the content is selected from one of the
number of times the content is read-out; and
speed at which the content is read-out.

5. The method as claimed in claim 4, wherein the number of times the content is read-out is determined based on type of file.

6. The method as claimed in claim 1, wherein the manual selection by the end user comprises:
selecting one of the plurality of recording layers to record the content by an end user.

7. The method as claimed in claim 1, wherein in automatic selection, an application program of a recording device selects one of the plurality of recording layers to record the content.

8. The method as claimed in claim 1, wherein the optical record carrier is one of DVD and Blu-ray disc.

9. A recorder (500) comprising:
a control unit (59) arranged to record content on at least one of a plurality of recording layers on an optical record carrier by means of a focused radiation beam, wherein the selection of the recording layer for recording the content is based on at least one of the following recording criteria:
characteristics of the content;
properties of the plurality of recording layers;
manual selection by an end user; and
automatic selection.

10. The recorder as claimed in claim 9, wherein, the recorder is one of DVD recorder and Blu-ray disc recorder.

11. A computer program code means arranged to perform a method, the method comprising recording content on at least one of a plurality of recording layers on an optical record carrier by means of a focused radiation beam, wherein the selection of the recording layer for recording the content is based on at least one of the following recording criteria:
characteristics of the content;
properties of the plurality of recording layers;
manual selection by an end user; and
automatic selection
